(19) United States
(12) Patent Application Publication
(10) Pub. No.: US 2026/0009418 A1
(43) Pub. Date: Jan. 8, 2026

(54) SELF-TAPPING EXPANSION BOLT

(71) Applicant: SUN THROUGH INDUSTRIAL CO., LTD., Changhua County (TW)

(72) Inventor: WU-CHIEH WANG, Changhua County (TW)

(21) Appl. No.: 18/761,480

(22) Filed: Jul. 2, 2024

(51) Int. Cl. F16B 13/00

(52) U.S. Cl. CPC F16B 13/002

(57) ABSTRACT

A self-tapping expansion bolt provided by the present invention contains a body, an expanded extension, and a nut. The body includes a drilling head and a grip. The drilling head has a cutter, at least one discharge trench, an expandable support portion, and outer threads. The expanded extension includes a first segment, a second segment, and multiple cutouts spirally surrounding from the first segment to the second segment. A spirally surrounding direction of the multiple cutouts is opposite to a rotating direction of the drilling head, and the expanded extension further includes multiple flexible sheets, a respective one sheet is defined between any two adjacent cutouts. A positioning manner is defined between the first segment and the expandable support portion, and the multiple cutouts are aligned and connected with the multiple discharge trenches of the drilling head. The nut is screwed with the outer threads of the body.

### TECHNICAL FIELD

The present invention relates to an expansion bolt, and more particularly to a self-tapping expansion bolt which is configured to engage on a wall or ground to fix an object.

### BACKGROUND

An anchor also called an expansion screw, are common fasteners that are placed in holes and used to achieve a fixing effect. A conventional anchor contains a bolt, an expanded extension, and a nut. The bolt includes an expandable support portion formed in a cone shape on an end of the bolt, outer threads formed on the other end of the bolt, wherein the expanded extension has multiple spaced recesses defined on an end thereof so as to form multiple flexible sheets on the end of the expanded extension, hence the bolt is inserted into the expanded extension so that the multiple expandable support portion of the bolt abuts against the multiple flexible sheets, and the nut is screwed with the outer threads of the bolt.

When desiring to fix the anchor, a drilling head is drilled into a cement wall or ground to form a hole, then the anchor is hit into the hole of the cement wall or ground, and the nut is rotated tightly by using a wrench. When the expanded extension is maintained fixedly, the bolt is pulled outward by pulling the nut so that the expandable support portion of the bolt is moved into the expanded extension to expend the multiple flexible sheets of the expanded extension outward so that the multiple flexible sheets are engaged with the cement wall, thus fixing the anchor.

However, when fixing the anchor, it is required to drill the hole in the cement wall so that the anchor is hit into the hole, thus increasing the fixing time and steps to cause troublesome operation. Also, when a size of the hole is drilled in an unsuitable size (such as a depth or a diameter), the anchor cannot be engaged or cannot be drilled in the hole, thus causing inconvenience.

The present invention has arisen to mitigate and/or obviate the afore-described disadvantages.

### SUMMARY

The primary aspect of the present invention is to provide a self-tapping expansion bolt that contains the drilling head, the multiple discharge trenches, and the multiple cutouts so as to be drilled into the cement wall or ground without drilling at least one hole in the cement wall or ground to save a fixing time and steps of the self-tapping expansion bolt, thus saving an operating time and labor. Also, it is evitable to engage the self-tapping expansion bolt with an insufficient force or cause a failure of an engagement of the self-tapping expansion bolt with the at least one hole, since a size of the at least one hole is unsuitable, thus enhancing a using utility and convenience.

To obtain above-mentioned aspects, a self-tapping expansion bolt provided by the present invention contains a body, an expanded extension, and a nut.

The body includes a drilling head formed on an end of the body, and the body includes a grip formed on the other end of the body. The drilling head is non-circular and has a cutter defined on an end of the drilling head, at least one discharge trench defined on an outer wall of the drilling head, an expandable support portion facing the grip, and outer threads formed between the grip and the expandable support trench.

The expanded extension includes a first segment and a second segment, multiple cutouts spirally surrounding from the first segment to the second segment. A spirally surrounding direction of the multiple cutouts is opposite to a rotating direction of the drilling head, and the expanded extension further includes multiple flexible sheets, a respective one sheet is defined between any two adjacent cutouts. The expanded extension is fitted on an outer wall of the body, the first segment of the expanded extension abuts against the expandable support portion, and a positioning manner is defined between the first segment of the expanded extension and the expandable support portion of the body so that the expanded extension rotates with the body simultaneously, and the multiple cutouts are aligned and connected with the multiple discharge trenches of the drilling head.

The nut is screwed with the outer threads of the body.

### BRIEF DESCRIPTION OF THE DRAWINGS

FIG. 1 is a perspective view showing the assembly of a self-tapping expansion bolt according to a preferred embodiment of the present invention.

FIG. 2 is a perspective view showing the exploded components of the self-tapping expansion bolt according to the preferred embodiment of the present invention.

FIG. 3 is a cross-sectional view showing the assembly of the self-tapping expansion bolt according to the preferred embodiment of the present invention.

FIG. 4 is a side plan view showing the operation of the self-tapping expansion bolt according to the preferred embodiment of the present invention.

FIG. 5 is another side plan view showing the operation of the self-tapping expansion bolt according to the preferred embodiment of the present invention.

FIG. 6 is a cross-sectional view showing the operation of the self-tapping expansion bolt according to the preferred embodiment of the present invention.

FIG. 7 is another cross-sectional view showing the operation of the self-tapping expansion bolt according to the preferred embodiment of the present invention.

FIG. 8 is a perspective view showing the assembly of a self-tapping expansion bolt according to another preferred embodiment of the present invention.

FIG. 9 is a perspective view showing the exploded components of the self-tapping expansion bolt according to another preferred embodiment of the present invention.

FIG. 10 is a cross-sectional view showing the operation of the self-tapping expansion bolt according to another preferred embodiment of the present invention.

FIG. 11 is another cross-sectional view showing the operation of the self-tapping expansion bolt according to another preferred embodiment of the present invention.

### DETAILED DESCRIPTION

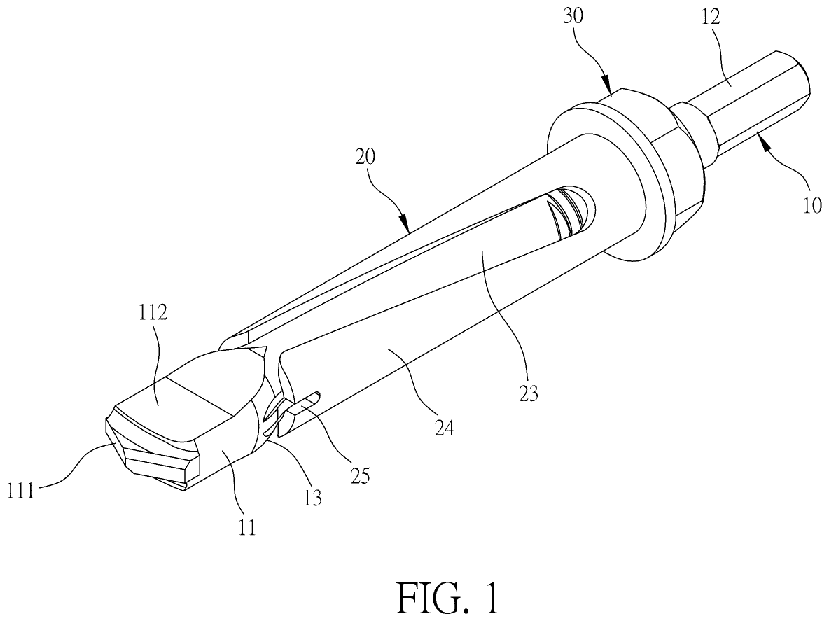

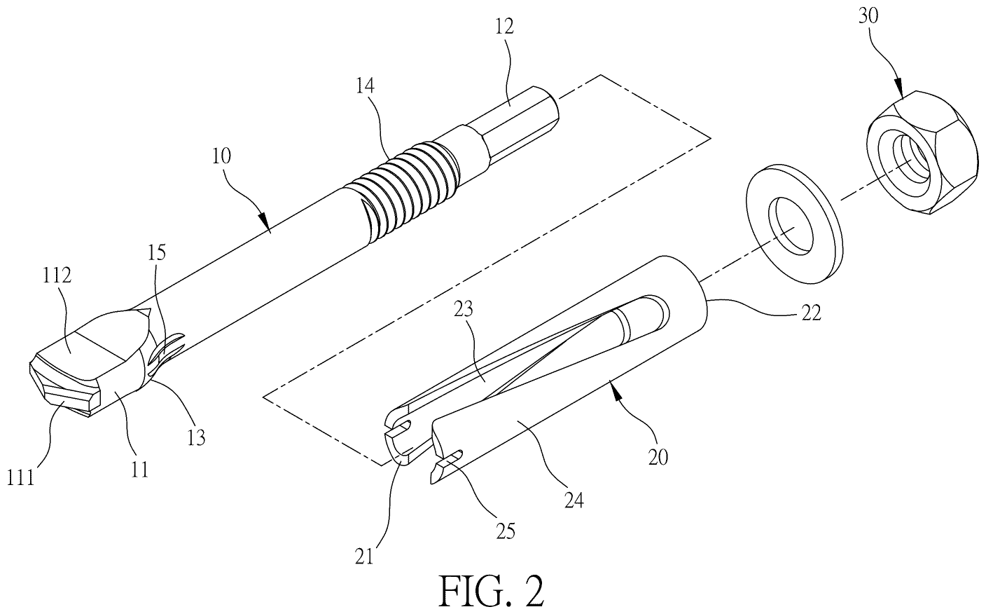

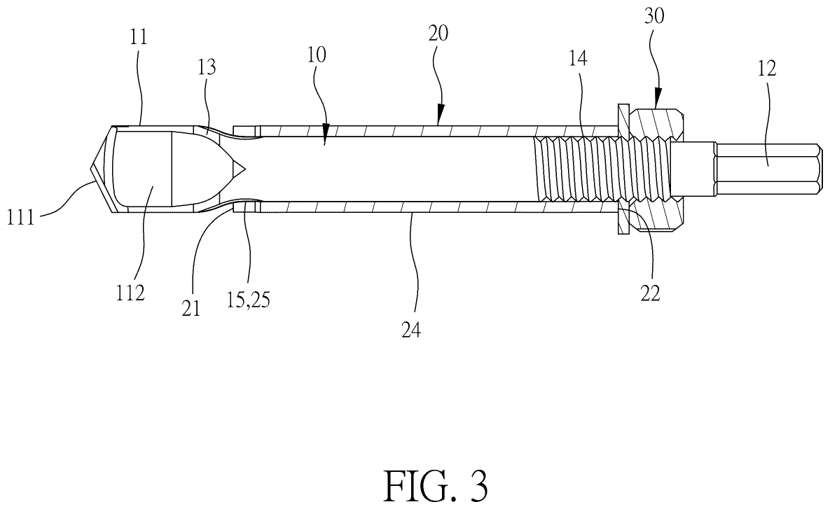

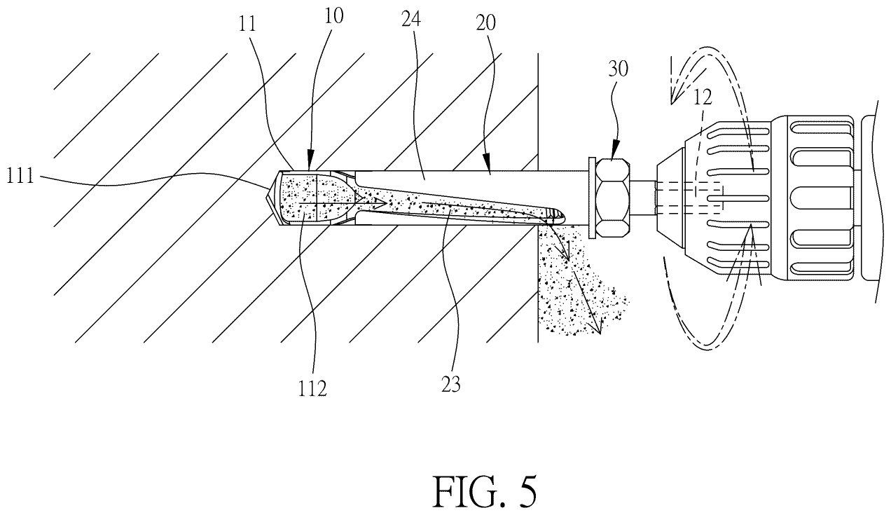

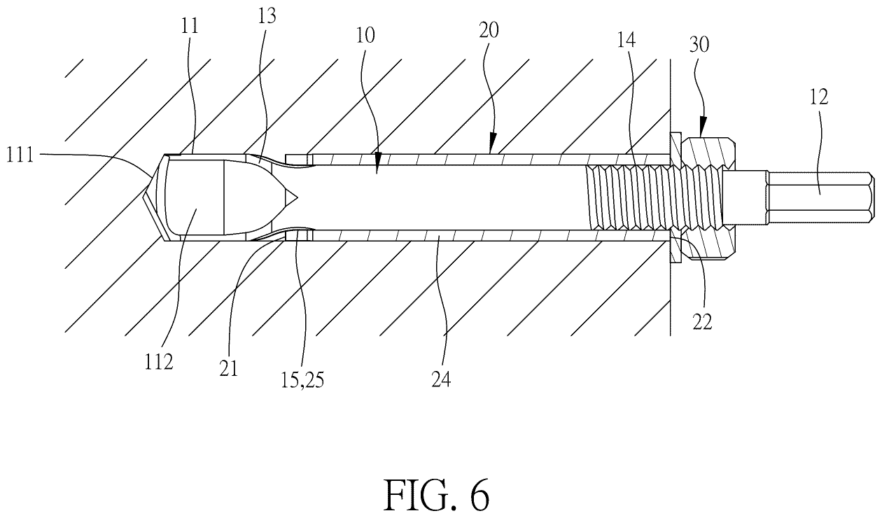

With reference to FIGS. 1-6, a self-tapping expansion bolt according to a preferred embodiment of the present invention comprises a body 10, an expanded extension 20, and a nut 30.

The body 10 includes a drilling head 11 formed on an end thereof, and the body 10 includes a hexagonal grip 12 formed on the other end thereof, wherein the drilling head 11 is non-circular and has a cutter 111 defined on an end of the drilling head 11, at least one discharge trench 112 defined on an outer wall of the drilling head 11, an expandable support portion 13 formed in a cone shape and facing the hexagonal grip 12, and outer threads 14 formed between the hexagonal grip 12 and the expandable support trench 13. In this embodiment, the drilling head 11 has two discharge trenches 112 defined on the outer wall thereof, and the outer threads 14 are formed adjacent to the hexagonal grip 12.

The expanded extension 20 includes a first segment 21 and a second segment 22, multiple cutouts 23 spirally surrounding from the first segment 21 to the second segment 22, wherein a spirally surrounding direction of the multiple cutouts 23 is opposite to a rotating direction of the drilling head 11, and the expanded extension 20 further includes multiple flexible sheets 24, a respective one sheet 24 is defined between any two adjacent cutouts 23. The expanded extension 20 is fitted on an outer wall of the body 10, the first segment 21 of the expanded extension 20 abuts against the expandable support portion 13, and a positioning manner is defined between the first segment 21 of the expanded extension 20 and the expandable support portion 13 of the body 10 so that the expanded extension 20 rotates with the body 10 simultaneously, and the multiple cutouts 23 are aligned and connected with the multiple discharge trenches 112 of the drilling head 11. In this embodiment, two opposite cutouts 23 of the expanded extension 20 spirally surround from the first segment 21 to the second segment 22, and the positioning manner includes at least one locating protrusions 15 extending from the expandable support portion 13 of the body 10, and at least one recess 25 defined on the first segment 21 of the expanded extension 20, such that the at least one locating protrusions 15 are engaged into the at least one recess 25 to fix the expanded extension 20 and the body 10.

The nut 30 is screwed with the outer threads of the body 10 and abuts against the expanded extension 20 so that the expanded extension 20 is limited between the expandable support portion 13 of the body 10 and the nut 30.

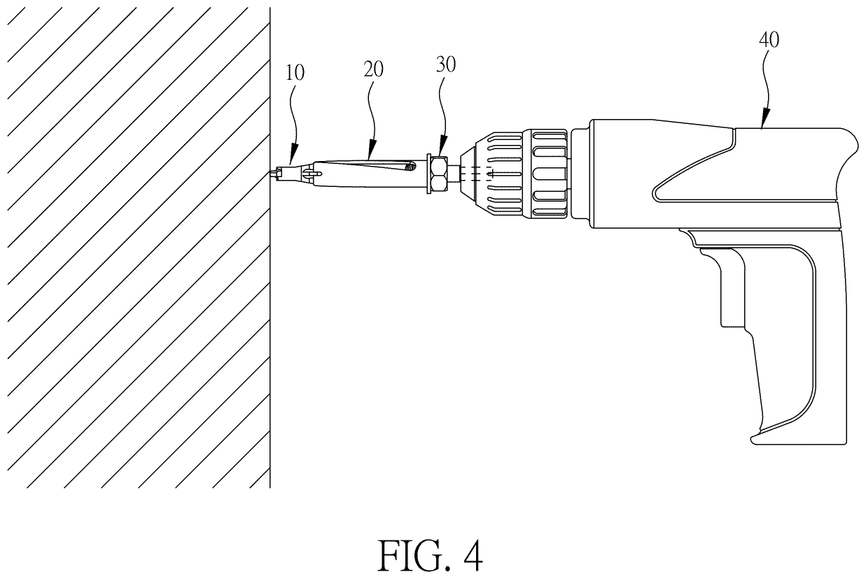

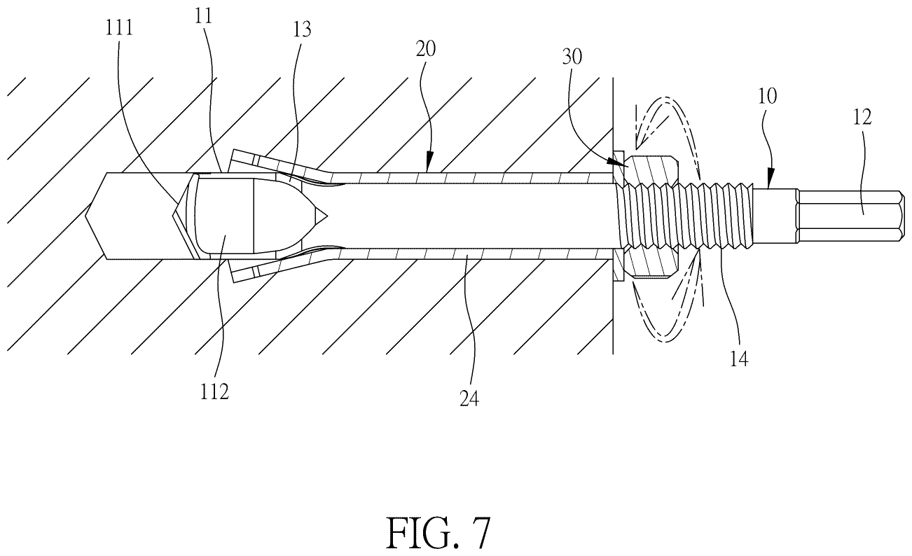

Referring to FIGS. 4-7, in a drilling process of the self-tapping expansion bolt, the hexagonal grip 12 of the body 10 is engaged on an electric drill 40 so that the electric drill 40 actuates the self-tapping expansion bolt to rotate, and the drilling head 11 of the body 10 is drilled into a cement wall or ground, in the meantime, drilled chips producing in the drilling process are discharged out of the multiple discharge trenches 112 of the drilling head 11 and the multiple cutouts 23 of the expanded extension 20 until the expanded extension 20 is completely moved into the cement wall or ground. Thereafter, the electric drill 40 is removed from the hexagonal grip 12 of the body 10, and the nut 30 is manually rotated tightly by using a wrench. When the expanded extension 20 is maintained fixedly, the nut 30 pulls the body 10 outward so that the expandable support portion 13 of the body 10 is moved into the expanded extension 20, and the multiple flexible sheets 24 of the expanded extension 20 are expanded outward in a slope to force the multiple flexible sheets 24 to engage with the cement wall or ground, thus fixing the self-tapping expansion bolt with the cement wall or ground stably to position an object.

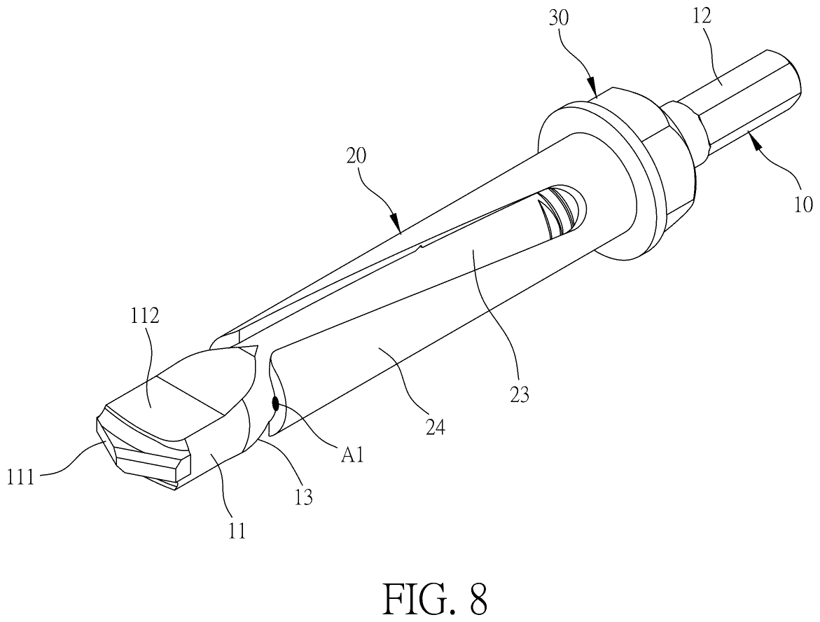

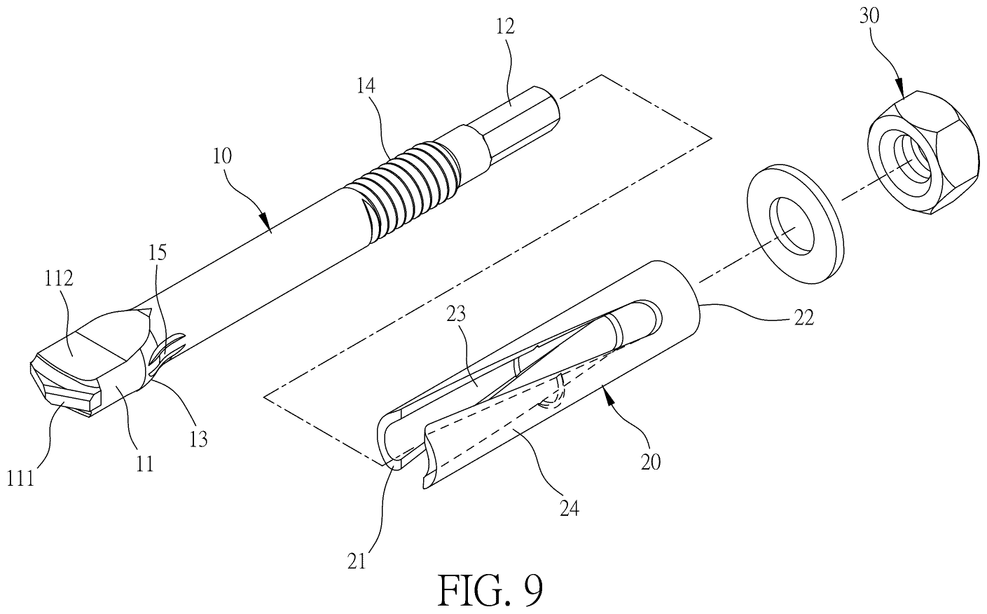

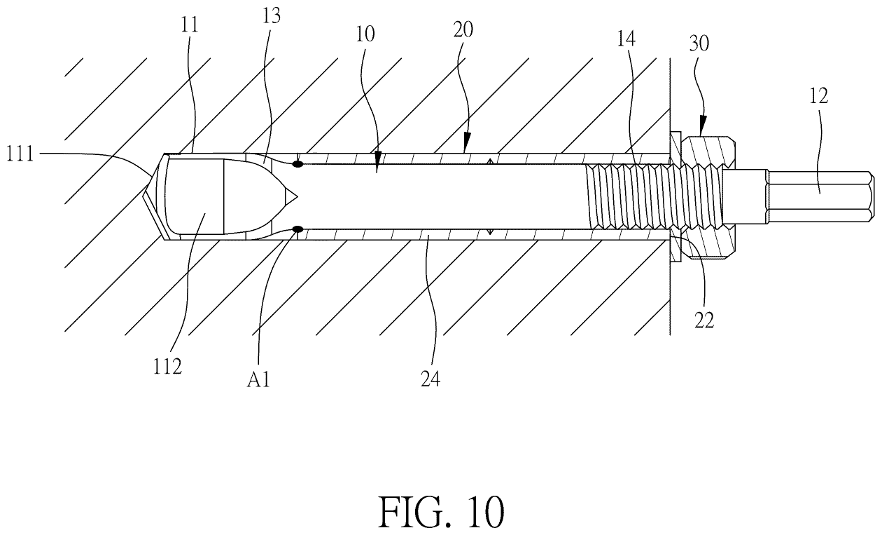

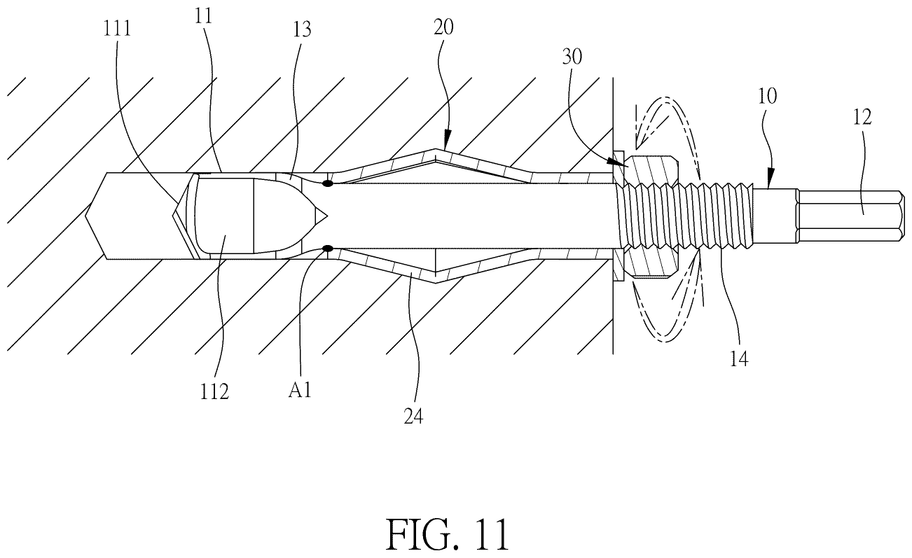

As shown in FIG. 8-11, in another embodiment, a difference of this embodiment from that of above-mentioned embodiment comprises a positioning manner by which an expandable support portion 13 of a body 10 is welded with a first segment 21 of an expanded extension 20 in a welding spot A1.

In use, the drilling head 11 of the body 10 is drilled into the cement wall or ground until the expanded extension 20 is completely moved into the cement wall or ground. Thereafter, the nut 30 is manually rotated tightly by using the wrench. When the expandable support portion 13 of the body 10 is welded with the first segment 21 of the expanded extension 20, the nut 30 pulls the body 10 outward so that the expandable support portion 13 of the body 10 actuates the multiple flexible sheets 24 of the expanded extension 20 to press outward in a horizontal V shape, and the multiple flexible sheets 24 are forced to engage with the cement wall or ground, thus fixing the self-tapping expansion bolt with the cement wall or ground stably to position an object.

Accordingly, the self-tapping expansion bolt of the present invention has advantages as follows:

The self-tapping expansion bolt contains the drilling head 11, the multiple discharge trenches 112, and the multiple cutouts 23 so as to be drilled into the cement wall or ground without drilling at least one hole on the cement wall or ground to save a fixing time and steps of the self-tapping expansion bolt, thus saving an operating time and labor. Also, it is evitable to engage the self-tapping expansion bolt with an insufficient force or cause a failure of an engagement of the self-tapping expansion bolt with the at least one hole, since a size of the at least one hole is unsuitable, thus enhancing a using utility and convenience.

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples, but should be given the broadest interpretation consistent with the description as a whole.

What is claimed is:

1. A self-tapping expansion bolt comprising:
a body including a drilling head formed on an end of the body, and the body including a grip formed on the other end of the body, wherein the drilling head is non-circular and has a cutter defined on an end of the drilling head, at least one discharge trench defined on an outer wall of the drilling head, an expandable support portion facing the grip, and outer threads formed between the grip and the expandable support trench;
an expanded extension including a first segment and a second segment, multiple cutouts spirally surrounding from the first segment to the second segment, wherein a spirally surrounding direction of the multiple cutouts is opposite to a rotating direction of the drilling head, and the expanded extension further includes multiple flexible sheets, a respective one sheet is defined between any two adjacent cutouts; the expanded extension is fitted on an outer wall of the body, the first segment of the expanded extension abuts against the expandable support portion, and a positioning manner is defined between the first segment of the expanded extension and the expandable support portion of the body so that the expanded extension rotates with the body simultaneously, and the multiple cutouts are aligned and connected with the multiple discharge trenches of the drilling head; and
a nut screwed with the outer threads of the body.

2. The self-tapping expansion bolt as claimed in claim 1, wherein the positioning manner includes at least one locating protrusion extending from the expandable support portion of the body, and at least one recess defined on the first segment of the expanded extension, such that the at least one locating protrusions are engaged into the at least one recess to fix the expanded extension and the body.

3. The self-tapping expansion bolt as claimed in claim 1, wherein the positioning manner is to weld the expandable support portion of the body with the first segment of the expanded extension in a welding spot.

4. The self-tapping expansion bolt as claimed in claim 1, wherein the grip is hexagonal, and the expandable support portion is formed in a cone shape.

5. The self-tapping expansion bolt as claimed in claim 1, wherein the outer threads are formed adjacent to the grip.
